(19) United States
(12) Patent Application Publication
(10) Pub. No.: US 2004/0042475 A1
(43) Pub. Date: Mar. 4, 2004

(54) Soft-pipelined state-oriented processing of packets

(76) Inventors: Bapiraju Vinnakota, Fremont, CA (US); Saleem Mohammadali, Marathahalli (IN); David W. Gilbert, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/231,605

(22) Filed: Aug. 30, 2002

(51) Int. Cl. H04L 12/28

(52) U.S. Cl. 370/412; 370/395.4; 370/252

(57) ABSTRACT

Embodiments of the invention relate to soft-pipelined state-oriented packet processing of packets received from a network. In one embodiment, a packet processor includes a packet processor core coupled to a program memory and an external memory to perform packet processing operations including defining a plurality of phases and a plurality of contexts, wherein each context includes a plurality of packets. The plurality of phases process each context. Further, a direct memory access (DMA) to the external memory is performed to obtain state data for the context being processed by the phase for use during processing by a next phase. After the last phase has processed the context, the state data is transferred back into the external memory using a final DMA transfer.

### BACKGROUND

1. Field

Embodiments of the invention relate to the field of packet processing. More particularly, embodiments of the invention relate to techniques for soft-pipelined state-oriented packet processing of packets received from a network.

2. Description of Related Art

Voice over Packet (VoP) technology deals with converting narrowband voice, fax and data traffic from circuit-switched formats used in telephone and wireless cellular networks to packets that can travel over packet based networks, such as Internet Protocol (IP) packet based networks or Asynchronous Transfer Mode (ATM) packet based networks. For example, Voice over Internet Protocol (VoIP), a subset of VoP, is a protocol developed specifically for delivering voice over the Internet using Internet Protocol. In general, VoP deals with sending and receiving voice data, fax, and other forms of data in digital form and in discrete packets, rather than in the traditional circuit-committed protocols of the public switched telephone network (PSTN). A major advantage of VoP is that avoids the tolls charged by ordinary telephone service.

Historically, over the past 30 years, two disparate networks have developed independently of one another that serve two distinct needs: the digital Public Switched Telephone Network (PSTN) for legacy voice traffic and the packet-based Internet for data traffic. Until recently, carriers and service providers focused on delivering either voice service over the PSTN or data service over a packet network (e.g. the Internet). However, after governmental deregulation of the U.S. telecommunications market in 1996, competition is increasingly forcing them to offer subscribers multiple services over a single connection.

Using a single-converged network to move narrowband voice, fax and data traffic from circuit-switched networks to packet based networks lets carriers and service providers take advantage of the efficiency, flexibility, and ubiquity of packet-based networks. A converged network lets service providers significantly expand both the number of customers and the variety of differentiated voice, video and data services over a single broadband connection at a lower cost. Thus, there has been tremendous interest by carriers and service providers to develop VoP technologies. However, a major challenge in the development of VoP technologies is to deliver the packetized voice, fax or other data (e.g. video data) in high volume dependable flows to the user.

Currently, high volume dependable flows of voice data (i.e. channels of voice data) are not readily achievable because the rate at which voice packets are received and processed from a network is less than desirable. Particularly, when processing voice packets, certain pieces of information need to be maintained between successive packets on the same flow. This collection of information is termed the state of the flow. Normally, a large amount of data (e.g. 64 to 80 bytes) makes up the state of a particular flow. When processing large numbers of flows (e.g. greater than 2000 flows), at any given time the amount of space required to hold all of the state information can be very large (e.g. more than 128 kb). Further, most current voice packet processing algorithms typically only process one packet at a time. Unfortunately, this slows down the speed of voice packet processing because state data has to be successively read from memory and in the mean time the processor performing the voice packet processing remains idle. This results in a less than desirable rate of voice packet processing and degrades the overall performance of delivering voice traffic over the packet-based network.

### BRIEF DESCRIPTION OF THE DRAWINGS

FIG. 1 shows an illustrative example of a voice and data communications system.

FIG. 2 is a simplified block diagram illustrating a conventional multi-service access device in which embodiments of the present invention can be practiced.

FIG. 3 is a simplified block diagram illustrating an example of a packet processing card in which embodiments of the present invention can be practiced.

FIG. 4 is a simplified block diagram illustrating an example of a packet processor in which embodiments of the present invention can be practiced.

FIG. 5 shows a flow diagram illustrating a soft-pipelining process according to one embodiment of the invention.

FIG. 6 illustrates a diagram that shows an overlap of data movement with the phase processing of contexts according to one embodiment of the present invention.

FIG. 7 shows a flow diagram illustrating a duplicate flow ID detection process, according to one embodiment of the present invention.

FIG. 8 illustrates one example of different types of data that can be stored by a shunt buffer according to one embodiment of the present invention.

FIG. 9 shows a flow diagram that illustrates a generalized method of shunt buffer processing according to one embodiment of the invention.

### DESCRIPTION

In the following description, the various embodiments of the present invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, types of data, protocols, procedures, components, networking equipment, electrical structures and circuits, are not described in detail, or are shown in block diagram form, in order not to obscure embodiments of the present invention. Furthermore, aspects of the invention will be described in particular embodiments but may be implemented in hardware, software, firmware, middleware, or a combination thereof.

In the following description, certain terminology is used to describe various environments in which embodiments of the present invention can be practiced. In general, a “communication system” comprises one or more end nodes having connections to one or more networking devices of a network. More specifically, a “networking device” comprises hardware and/or software used to transfer information through a network. Examples of a networking device include a multi-access service device, a router, a switch, a repeater, or any other device that facilitates the forwarding of information. An “end node” normally comprises a combination of hardware and/or software that constitutes the source or destination of the information. Examples of an end node include a switch utilized in the Public Switched Telephone Network (PSTN), Local Area Network (LAN), Private Branch Exchange (PBX), telephone, fax machine, video source, computer, printer, workstation, application server, set-top box and the like. “Data traffic” generally comprises one or more signals having one or more bits of data, address, control, or any combination thereof transmitted in accordance with any chosen packeting scheme. Particularly, “data traffic” can be data, voice, address, and/or control in any representative signaling format or protocol. A “link” is broadly defined as one or more physical or virtual information carrying mediums that establish a communication pathway such as, for example, optical fiber, electrical wire, cable, bus traces, wireless channels (e.g. radio, satellite frequency, etc.) and the like.

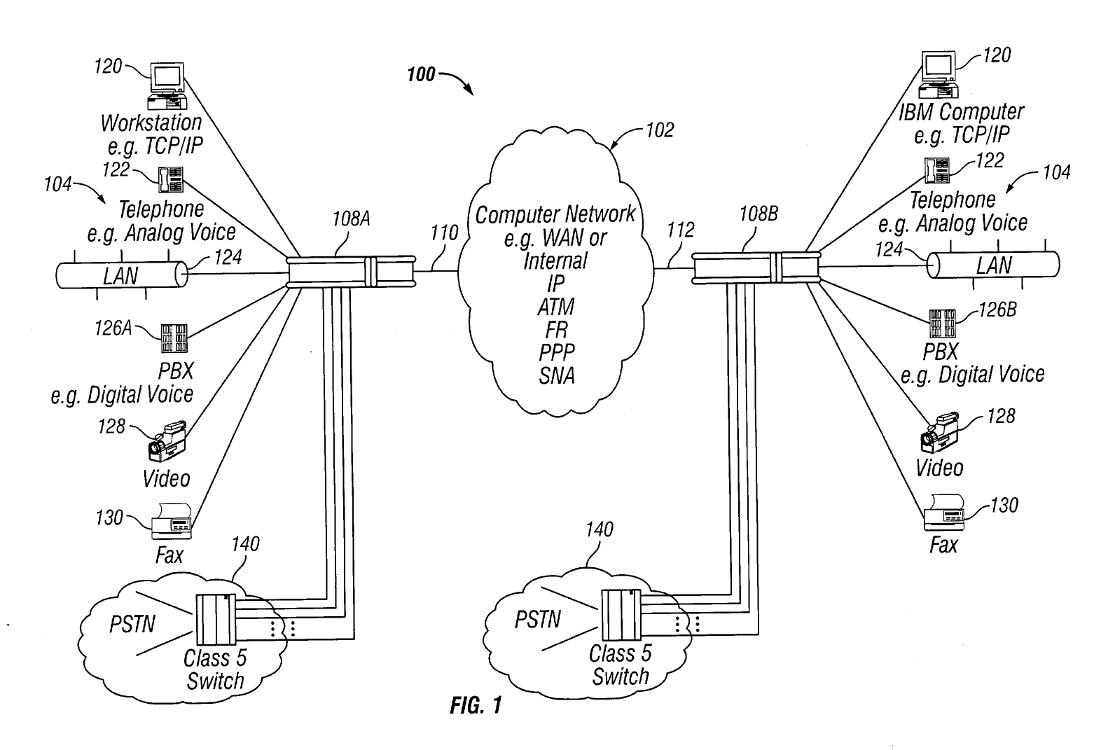

FIG. 1 shows an illustrative example of a voice and data communications system 100. The communication system 100 includes a computer network (e.g. a wide area network (WAN) or the Internet) 102 which is a packetized or a packet-switched network that can utilize Internet Protocol (IP), Asynchronous Transfer Mode (ATM), Frame Relay (FR), Point-to Point Protocol (PPP), Systems Network Architecture (SNA), or any other sort of protocol. The computer network 102 allows the communication of data traffic, e.g. voice/speech data and other types of data, between any end nodes 104 in the communication system 100 using packets. Data traffic through the network may be of any type including voice, graphics, video, audio, e-mail, fax, text, multi-media, documents and other generic forms of data. The computer network 102 is typically a data network that may contain switching or routing equipment designed to transfer digital data traffic. At each end of the communication system 100 the voice and data traffic requires packetization when transceived across the network 102.

The communication system 100 includes networking devices, such as multi-service access devices 108A and 108B, in order to packetize data traffic for transmission across the computer network 102. A multi-service access device 108 is a device for connecting multiple networks (e.g. a first network to a second network) and devices that use different protocols and also generally includes switching and routing functions. Access devices 108A and 108B are coupled together by network links 110 and 112 to the computer network 102.

Voice traffic and data traffic may be provided to a multi-service access device 108 from a number of different end nodes 104 in a variety of digital and analog formats. For example, in the exemplary environment shown in FIG. 1, the different end nodes include a class 5 switch 140 utilized as part of the PSTN, computer/workstation 120, a telephone 122, a LAN 124, a PBX 126, a video source 128, and a fax machine 130 connected via links to the access devices. However, it should be appreciated any number of different types of end nodes can be connected via links to the access devices. In the communication system 100, digital voice, fax, and modem traffic are transceived at PBXs 126A, 126B, and switch 140, which can be coupled to multiple analog or digital telephones, fax machines, or data modems (not shown). Particularly, the digital voice traffic can be transceived with access devices 108A and 108B, respectively, over the computer packet network 102. Moreover, other data traffic from the other end nodes: computer/workstation 120 (e.g. TCP/IP traffic), LAN 124, and video 128, can be transceived with access devices 108A and 108B, respectively, over the computer packet network 102.

Also, analog voice and fax signals from telephone 122 and fax machine 130 can be transceived with multi-service access devices 108A and 108B, respectively, over the computer packet network 102. The access devices 108 convert the analog voice and fax signals to voice/fax digital data traffic, assemble the voice/fax digital data traffic into packets, and send the packets over the computer packet network 102.

Thus, packetized data traffic in general, and packetized voice traffic in particular, can be transceived with multi-service access devices 108A and 108B, respectively, over the computer packet network 102. Generally, an access device 108 packetizes the information received from a source end node 104 for transmission across the computer packet network 102. Usually, each packet contains the target address, which is used to direct the packet through the computer network to its intended destination end node. Once the packet enters the computer network 102, any number of networking protocols, such as TCP/IP, ATM, FR, PPP, SNA, etc., can be employed to carry the packet to its intended destination end node 104. The packets are generally sent from a source access device to a destination access device over virtual paths or a connection established between the access devices. The access devices are usually responsible for negotiating and establishing the virtual paths or connections. Data and voice traffic received by the access devices from the computer network are depacketized and decoded for distribution to the appropriate destination end node. It should be appreciated that the FIG. 1 environment is only an exemplary illustration to show how various types of end nodes can be connected to access devices and that embodiments of the present invention can be used with any type of end nodes, network devices, computer networks, and protocols.

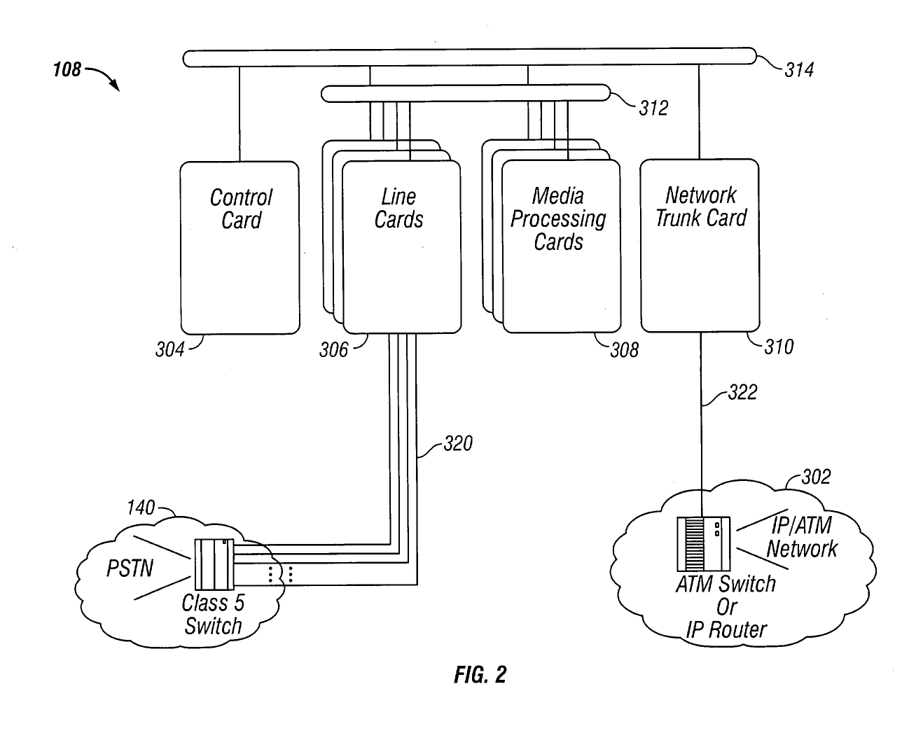

FIG. 2 is a simplified block diagram illustrating a conventional multi-service access device 108 in which embodiments of the present invention can be practiced. As shown in FIG. 2, the conventional multi-service access device 108 includes a control card 304, a plurality of line cards 306, a plurality of media processing cards 308, and a network trunk card 310. Continuing with the example of FIG. 1, the switch 140 can be connected to the multi-service access device 108 by connecting cables into the line cards 306, respectively. On the other side, the network trunk card 310 can connect the multi-service access device 108 to the computer network 102 (e.g. the Internet) through an ATM switch or IP router 302. All of the various cards in this exemplary architecture can be connected through standard buses. As an example, all of the cards 304, 306, 308, and 310, are connected to one another through a Peripheral Component Interconnect (PCI) bus 314. The PCI bus 314 connects the network trunk card 310 to the media processing cards 308 and carries the packetized traffic and/or control and supervisory messages from the control card 304. Also, the line cards 306 and the media processing cards 308 are particularly connected to one another through a bus 312. The bus 312 can be a Time Division Multiplexing (TDM) bus (e.g. an H.110 computer telephony bus) that carries the individual timeslots from the line cards 306 to the media processing cards 308.

In this example, the multi-service access device 108 can act as a Voice over Packet (VoP) gateway to interface a digital TDM switch 140 on the PSTN side to a router or ATM switch 302 on the IP/ATM side. The connection to the TDM switch may be a group of multiple T1/E1/J1 cable links 320 forming a GR-303 or V5.2 interface whereas the IP/ATM interface may be a Digital Signal Level 3 (DS3) or Optical Carrier Level 3(OC-3) cable link 322 or higher. Thus, in this example, the multi-service access device 108 can perform the functions of providing voice over a computer network, such as the Internet.

Looking particularly at the cards, the control card 304 typically acts as a supervisory element responsible for centralized functions such as configuring the other cards, monitoring system performance, and provisioning. Functions such as signaling, gateway, or link control may also reside in this card. It is not uncommon for systems to offer redundant control cards given the critical nature of the functions they perform. As to the media processing cards 308, as the name indicates, these cards are responsible for processing media- e.g. voice traffic. This includes tasks such as timeslot switching, voice compression, echo canceling, comfort noise generation, etc. Packetization of the voice traffic may also reside in this card. The network trunk card 310 contains the elements needed to interface to the packet network. The network trunk card 310 maps the network packet (cells) into a layer one physical interface such as DS-3 or OC-3 for transport over the network backbone. As to the line cards 306, these cards form the physical interface to the multiple T1/E1/J1 cable links 320. These cards provide access to the individual voice timeslots and to the “control” channels in a GR-303 or V5.2 interface. The line cards 306 also provide access to the TDM signaling mechanism.

It should be appreciated that this is a simplified example of a multi-service access device 108 used to highlight aspects of embodiments of the present invention for soft-pipelined state-oriented packet processing. Furthermore, it should be appreciated that other generally known types of networking devices, multi-service access devices, routers, gateways, switches, wireless base stations etc., that are known in the art, can just as easily be used with embodiments of the present invention for soft-pipelined state-oriented packet processing.

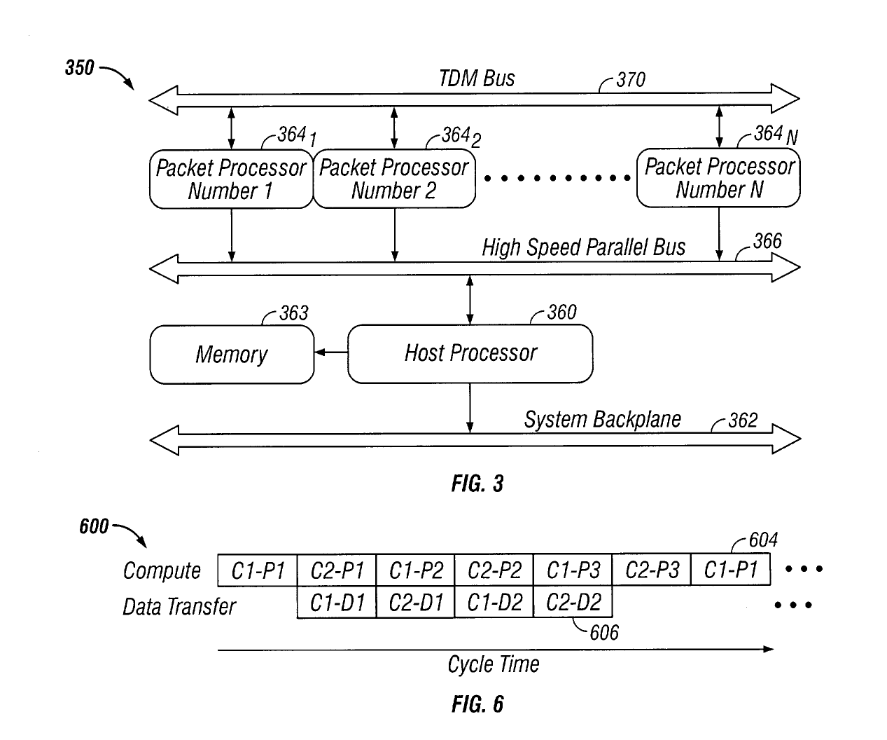

FIG. 3 is a simplified block diagram illustrating an example of a packet processing card 350 in which embodiments of the present invention can be practiced. The packet processing card 350 can be one of the media processing cards 308 or part of one of the media processing cards 308. In one example, the packet processing card 350 can be a voice processing card that performs TDM-to-packet interworking functions that involve Digital Signal Processing (DSP) functions on payload data, followed by packetization, header processing, and aggregation to create a high-speed packet stream.

In the voice processing example, the voice processing functionality can be split into control-plane and data-plane functions, which have different requirements. For example, the control-plane functions include board and device management, command interpretation, call control and signaling conversation, and messaging to call-management servers. The data-plane functions are provided by the bearer channel (which carries all the voice and data traffic) which include all TDM-to-packet processing functions: DSP, packet processing, header processing, etc.

FIG. 3 illustrates a packet processing card 350 having a host processor 360 (e.g. an aggregation engine) connected to a system backplane 362, a memory 363, and a high-speed parallel bus 366. The host processor 360 is connected to a plurality of packet processors 364_{1-N} by the high-speed parallel bus 366. The packet processors 364_{1-N} are further connected to a bus 370 (e.g. a TDM bus). The packet processors 364_{1-N,} in one example, can be considered to be DSP devices that generate protocol data unit (PDU) traffic. The packet processing card 350 has a centralized memory 363 for packet buffering and streaming over the packet interface to the switched fabric or packet backplanes. The memory 363 being located in the packet processing card 350 significantly reduces the memory required on the packet processor 364_{1-N} and eliminates the need for external memory for each packet processor, greatly reducing total power consumption enabling robust scalability and packet processing resources.

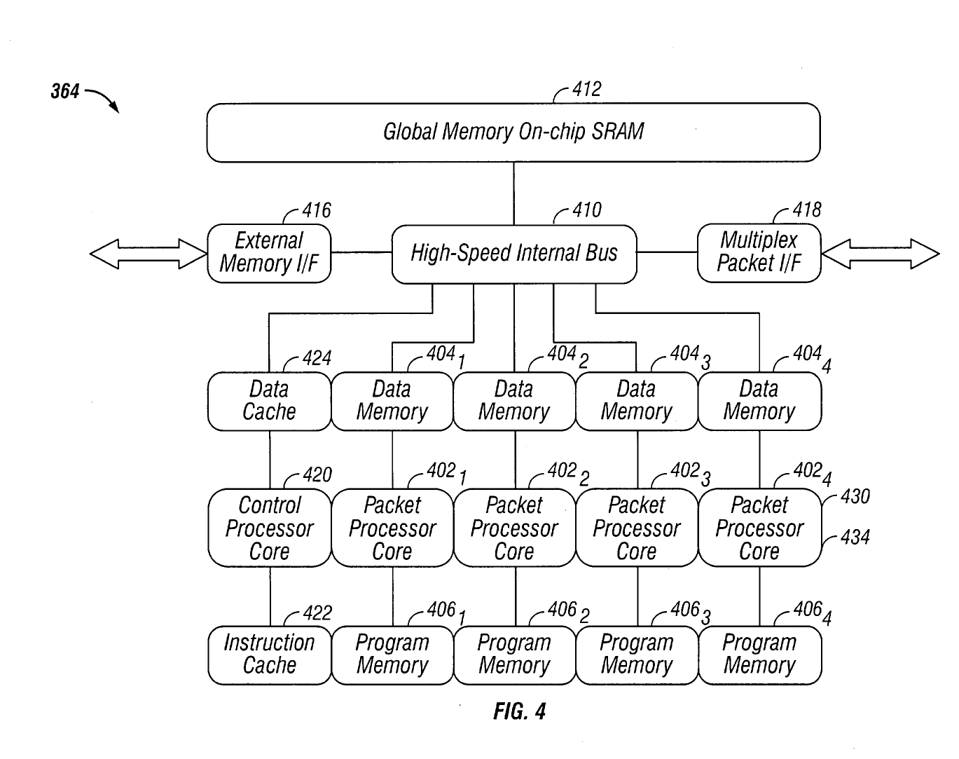

FIG. 4 is a simplified block diagram illustrating an example of a packet processor 364 in which embodiments of the present invention can be practiced. As shown in FIG. 4, the packet processor 364 includes all of the functional blocks necessary to interface with various network devices and buses to enable packet and voice processing subsystems. In this example, the packet processor 364 includes four packet processor cores 402₁₋₄. However, four packet processor cores 402₁₋₄ are only given as an example, and it should be appreciated that any number of packet processor cores can be utilized. The packet processor cores 402₁₋₄ execute algorithms needed to process protocol packets. Moreover, dedicated local data memory 404₁₋₄ and dedicated local program memory 406₁₋₄ are coupled to each packet processor core 402₁₋₄, respectively. A high-speed internal bus 410 and distributed DMA controllers provide the packet processor cores 402₁₋₄ with access to data in a global memory 412. At one end, the packet processor 364 includes an external memory interface port 416 connected to the high-speed internal bus 410 for access to external memory. At the other end, the packet processor 364 includes a multiple packet bus interface 418 connected to the high-speed internal bus 410. For example, the packet bus interface 418 can be a 32-bit parallel host bus interface for transferring voice packet data and programming the device. Further, the packet bus interface 418 may be a standard interface such as a PCI interface or a Utopia Interface.

The packet processor 364 further includes a control processor core 420 (e.g. a RISC based control processor) coupled to an instruction cache 422 and a data cache 424, which are all coupled to the high-speed internal bus 410. The control processor core 420 schedules tasks and manages data flows for the packet processor cores 402₁₋₄ and manages communication with an external host processor. Thus, in addition to the packet processor cores 402₁₋₄, the packet processor 364 includes a RISC based control processor core 420, which manages communication between a system host processor and within the packet processor 364 itself. The control processor core 420 is responsible for scheduling and managing flows of incoming data to one of the packet processor cores 402₁₋₄ and invoking the appropriate program on that packet processing core for processing data. This architecture allows the packet processor cores to concentrate on processing data flows, thus achieving high packet processor core utilization in computational performance. It also eliminates bottlenecks that would occur when the system is scaled upward if all the control processing had to be handled at higher levels in the system.

Embodiments of the invention relate to soft-pipelined state-oriented packet processing techniques for packets received from a network. For example, in one embodiment, programs stored in each of the program memories 406 may be used to implement the soft-pipelined processing techniques in conjunction with each of the packet processor cores 402, respectively, to implement aspects of the invention. The soft-pipelined processing programs can be utilized by packet processor cores 402 to perform effective soft-pipelined state-oriented packet processing techniques. These soft-pipelined processing techniques will be discussed in detail in the following sections.

However, it should be appreciated that although the example network environment 100 was shown in FIG. 1, the example of a multi-service access device 108 was shown in FIG. 2, the example of a packet processing card 350 was shown in FIG. 3, and the example of a packet processor 364 was shown in FIG. 4, that these are only examples of environments (e.g. packet processing cards, packet processors, and network devices) that the soft-pipelined processing techniques according to embodiments of the invention can be used with. Further, it should be appreciated that the soft-pipelined processing techniques according to embodiments of the invention can be implemented in a wide variety of packet processing cards, packet processors, and known network devices- such as other types of multi-service access devices, routers, switches, wireless base stations, ATM gateways, frame relay access devices, purely computer based networks (e.g. for non-voice digital data), other types of voice gateways and combined voice and data networks, etc., and that the previous described multi-service access device and VoP environment is only given as an example to aid in illustrating one potential environment for the soft-pipelined processing techniques according to embodiments of the invention, as will now be discussed.

Further, those skilled in the art will recognize that the exemplary environments illustrated in FIGS. 1-4 are not intended to limit the present invention. Moreover, while aspects of the invention and various functional components have and will be described in particular embodiments, it should be appreciated these aspects and functionalities can be implemented in hardware, software, firmware, middleware or a combination thereof.

Embodiments of the invention relating to soft-pipelined state-oriented packet processing techniques for packets received from a network are used to increase the rate at which voice packets received from a network are processed by a packet processor. Increased throughput of voice packets brings an increase in channel density, which is the number of channels, or flows of voice data that can be active simultaneously. Higher channel density allows the voice processing system to handle more calls with fewer physical devices, thus providing higher service for less cost. Particularly, embodiments of the invention for soft-pipelined packet processing optimizes the throughput of voice packets by overlapping the processing time for one group of voice packets with the data movement time of another group of voice packets, while preserving functional correctness even when a substantial flow state has to be maintained.

More particularly, embodiments of the invention relate to soft-pipelined state-oriented packet processing of packets received from a network. In one embodiment, a packet processor includes a packet processor core coupled to a program memory and an external memory. The program memory stores a processor readable medium having instructions for use in packet processing which when executed by the packet processor core cause the packet processor core to perform a number of operations.

These operations include defining a plurality of phases and a plurality of contexts wherein each context includes a plurality of packets. The plurality of phases process each context. Further, a direct memory access (DMA) to an external memory is performed to obtain state data for the context being processed by the phase for use during processing by a next phase. After the last phase has processed the context, state data is transferred back into the external memory using a final DMA transfer. Also, a duplicate flow ID detection process to identify packets of contexts that have the same flow ID may be utilized. If packets of contexts that have the same flow ID are identified, the packets are stored into a shunt buffer. The packets stored in the shunt buffer can then be processed later. This prevents a race condition from occurring between two phases that are processing the same flow ID.

For example, in one embodiment, an example packet processor core 402 of packet processor 364 can be used to implement these operations (FIG. 4). Moreover, in this embodiment, the packet processor core 402 may utilize DMAs to data memory 404 or through external memory interface 416 to external memory 363 (FIGS. 3 and 4).

Embodiments of the invention relating to soft-pipelined state-oriented packet processing techniques implement soft-pipelining in a unique way. In the soft-pipelined technique, the processing of voice packets received from the network is broken up into different phases, and each phase processes a group of packets, called a context. It should be appreciated that the terms voice packets and packets are used interchangeably throughout this document, however, it should be appreciated to those skilled in the art that the embodiments of the invention are not limited solely to the processing of voice packets but can be applied to any type of data packet.

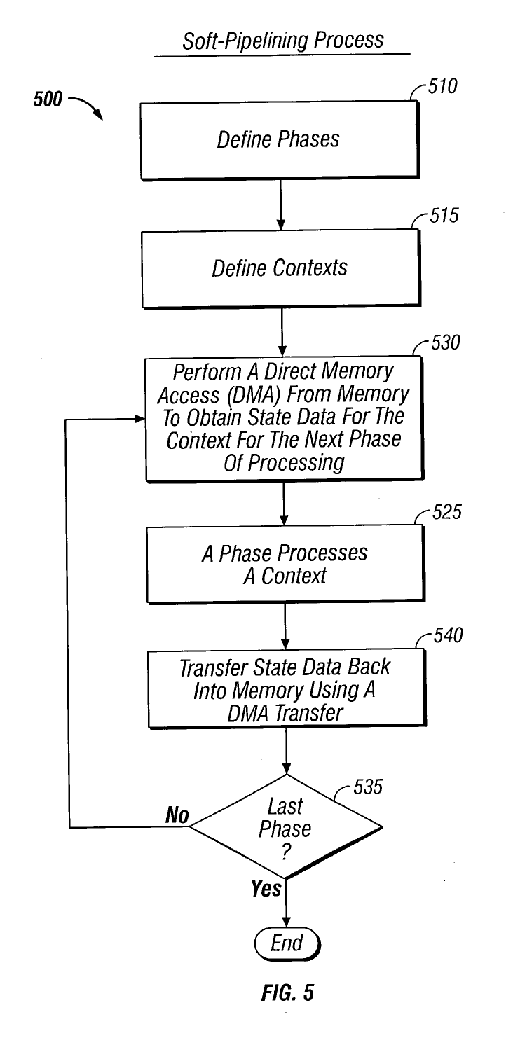

With reference now to FIG. 5, FIG. 5 shows a flow diagram illustrating a soft-pipelining process 500, according to one embodiment of the invention. First, the soft-pipelining process 500 defines a plurality of phases (block 510). Next, the soft-pipelining process 500 defines a plurality of contexts (block 515). At block 530, a direct memory access (DMA) is performed to obtain state data for the context for the next phase of processing. Next, at block 525 of the soft-pipelining process 500, a particular phase processes a particular context (block 525). It should be appreciated that one context is processed at a time per phase and that different phases operate on different contexts. Each context moves through successive phases until all the processing is complete. Next, at block 540, after processing, the state data is transferred back into memory using a DMA transfer (block 540).

At block 535, the soft-pipelining process 500 determines whether or not this is the last phase. If this is not the last phase, the soft-pipelining process 500 returns to block 530 to obtain state data for the context for the next phase of processing and the soft-pipelining process 500 continues. Thus, in between processing, a direct memory access (DMA) transfer is performed that brings in all of the data required by the packets in the context for the next phase of processing. On the other hand, if it is determined at block 535 that this is the last phase, the soft-pipelining process 500 ends.

Accordingly, when multiple contexts are active, the processing phase of one context can be overlapped by the DMA transfer phase of another context. In this way, the processing core is always active and the packet throughput increases. For example, in one embodiment, an example packet processor core 402 of packet processor 364 can be used to implement this process (FIG. 4). Moreover, in this embodiment, the packet processor core 402 may utilize DMAs to data memory 404 or through external memory interface 416 to memory 363 (FIGS. 3 and 4).

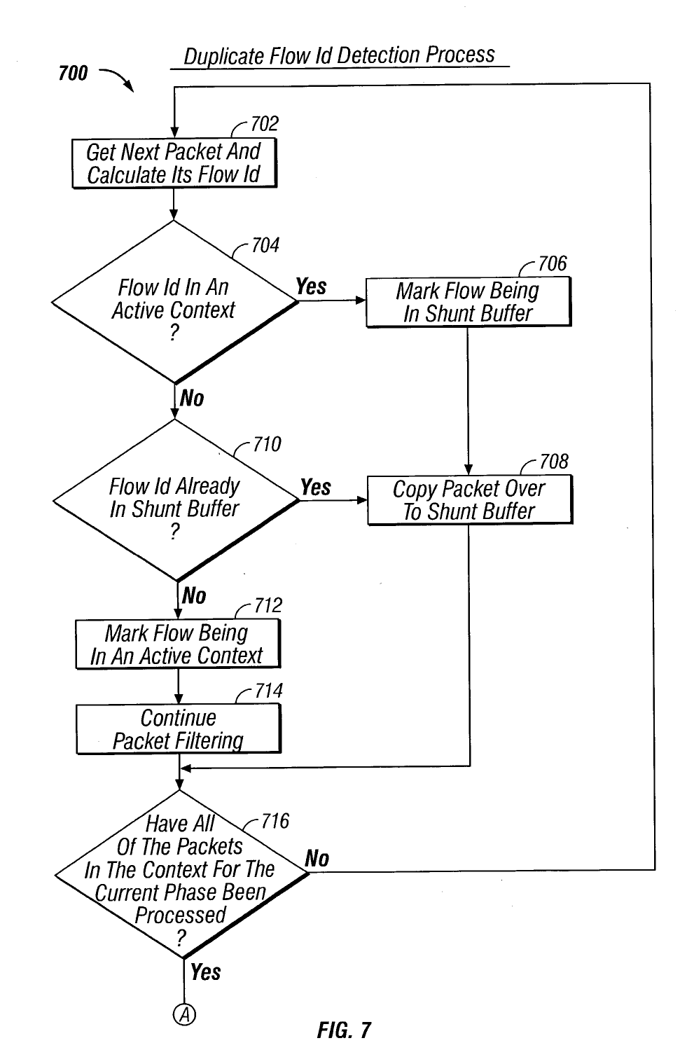

Turning now to FIG. 6, FIG. 6 illustrates a diagram that shows an overlap of data movement (e.g. DMAs) with the phase processing of contexts, according to one embodiment of the present invention. As shown in FIG. 6, the top series of blocks 604 illustrates a plurality of contexts being processed by various compute phases, for example, in a packet processor core. The bottom series of blocks 606 shows the data movement for the contexts that is required between processing phases. Particularly, FIG. 6 shows two simultaneously active contexts (e.g. C1, C2), and each context being processed over a set of three compute phases (e.g. P1, P2, and P3).

As to data transfers, between phases P1 and P2 a data transfer D1 to bring in the state data is performed. Similarly, a data transfer D2 is performed between phases P2 and P3 to store back changes to the state data. Accordingly, FIG. 6 shows that the processing time can be overlapped with a data transfer time when using at least two contexts. This assumes that the processing and data transfer times are approximately the same. However, if the data transfer time becomes greater than the processing time, more contexts can be added to keep the packet processor core from becoming idle.

Embodiments of the invention related to soft-pipelined state-oriented packet processing techniques further include aspects related to rapid context processing. Each context typically consists of multiple packets. The memory and compute costs of processing these packets can be significantly reduced by assuming that across all contexts, that no more than one packet per flow is present. The processing time may be reduced significantly by using this assumption. For example, packets from a flow may be identified by a flow ID. Particularly, packet processing can be accelerated by assuming that contexts do not contain packets with identical or duplicate flow IDs. It is reasonable to assume that there are no duplicate flow IDs because: a) packets in an audio flow are usually expected to be separated in time by an aggregation latency (typically at least 5 milliseconds); and b) the time taken to process a context is of the order of a few microseconds.

However, in practice, although violations are expected to be infrequent, this assumption cannot always be guaranteed to be true. This is because the order and rate at which packets are received from a network is not predictable. It should be appreciated that, while processing a group of packets in a context increases the DMA and processing efficiency, there is a relatively small potential for data conflict with packets within the same context or across other active contexts that share the same flow ID and thus must share the same state information. When coming from the network, the packets may arrive in nearly random fashion, and packets with the same flow ID may arrive near to one another and thus be collected into the same or nearby contexts. In this case, a race condition occurs when one context must write state information and a following context needs to read the updated state information or when two packets within the same context need to update the same state information.

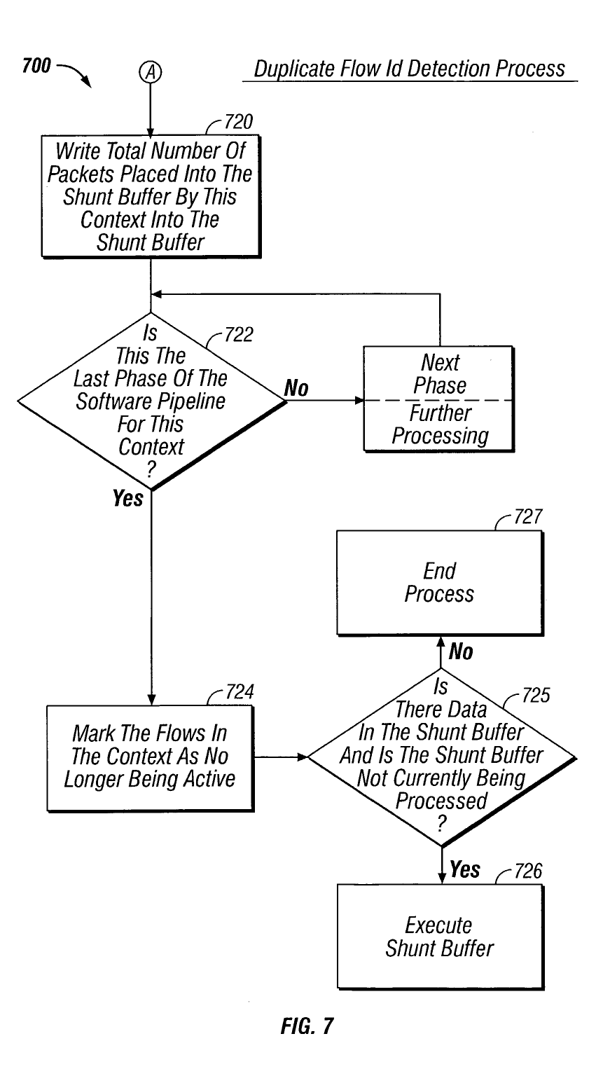

In order to accommodate the race condition, a duplicate flow ID detection process is needed. The duplicate flow ID detection process is made as part of one of these phases. FIG. 7 shows a flow diagram illustrating a duplicate flow ID detection process 700, according to one embodiment of the present invention. As will be described, the duplicate flow ID detection process 700: 1) enables rapid packet processing within each context by assuming there is no flow ID duplication within the context; and 2) provides a correct, efficient way to detect and handle duplicate flows within and across active contexts when they occur. Further, in some embodiments, the duplicate flow ID detection process 700 may include a shunt buffer processing mechanism. The shunt buffer holds packets with duplicate flow IDs until the original packet with the same flow ID has finished updating the state information for that flow. FIG. 7 illustrates the duplicate flow ID detection process including the basic algorithm for detecting and handling a packet with a duplicate flow ID.

Turning now to FIG. 7, at block 702 the duplicate flow ID detection process 700 obtains the next packet and calculates the packet's flow ID. It should be appreciated that the duplicate flow ID detection process 700 is an iterative process. At block 704, the flow ID is checked against a list of flow IDs that are currently active. If the flow ID is found to be currently active, then the flow ID for the packet is marked as being in the shunt buffer (block 706), the packet is copied over to the shunt buffer (block 708) and the duplicate flow ID detection process 700 proceeds to decision block 716, which will be discussed later.

On the other hand, if at block 704 the flow ID is not in an active context, then at block 710 it is determined whether or not the flow ID is already in the shunt buffer. If the flow ID is already in the shunt buffer, then the packet is copied over to the shunt buffer (block 708) and the duplicate flow ID detection process 700 proceeds to decision block 716, which will be discussed later.

Thus, the flow ID for a packet is checked against a list of flow IDs that are currently active and a list of flows that are already in the shunt buffer, and if either the flow ID is currently active or the flow ID is already in the shunt buffer, then the flow ID for the packet is a duplicate.

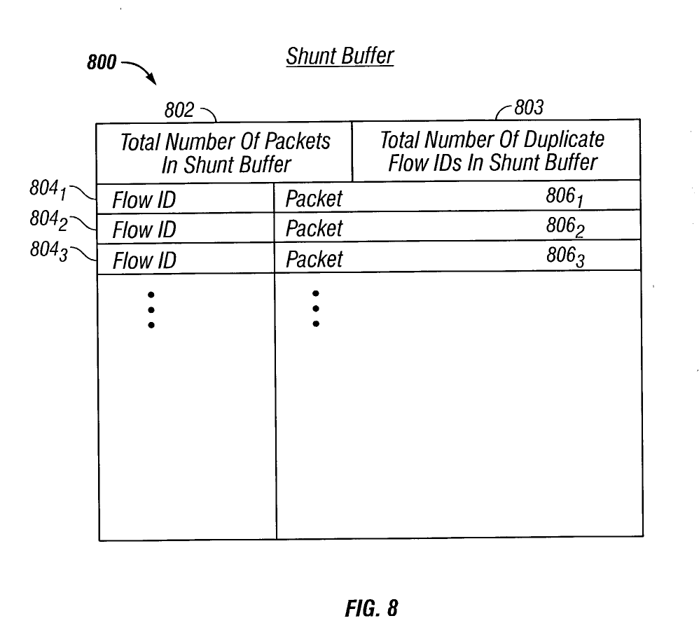

Turning briefly to FIG. 8, FIG. 8 illustrates one example of different types of data that can be stored by the shunt buffer 800 according to one embodiment of the present invention. For example, the shunt buffer 800 can include the total number of packets in the shunt buffer 802, the total number of duplicate flow IDs in the shunt buffer 803, particular flow IDs 804_{1-N} and their respective packets 806_{1-N}. It should be appreciated that this is only one example of a shunt buffer and a multitude of different types of shunt buffers having different types of data can be used. Moreover, the memory and processing requirements of the duplicate flow ID detection process 700 can be reduced by storing the list of active flows and those in the shunt buffer as packed bit arrays. Also, it should be appreciated that the compute time for the duplicate flow ID detection process may be a constant and independent of the number of flows when packed bit arrays are utilized.

Returning again to FIG. 7, thus, if a duplicate flow ID has been detected at either block 704 or block 710, the packet is copied to the shunt buffer and the number of packets in the shunt buffer from the current context is incremented. The packet's information is then removed from the current context. Also, the flow ID is marked as being in the shunt buffer.

On the other hand, if a duplicate flow ID is not detected at either block 704 or block 710, then the flow ID detection process 700 marks the flow as being in an active context (block 712) and packet filtering is continued (block 714).

In either event, the flow ID detection process 700 at block 716 next determines whether all of the packets in the context for the current phase have been processed. If not, the flow ID detection process 700 returns to block 702 where the next packet is obtained and the process begins again. On the other hand, if all of the packets in the context for the current phase have been processed, then the total number of packets placed into the shunt buffer by this context so far are written to the shunt buffer (block 720). In this way, the total number of packets placed into the shunt buffer (e.g. data field 802 of FIG. 8) is continuously incremented.

Next, at block 722, the duplicate flow ID detection process 700 determines whether the context has reached the last phase of the software pipeline for this context. If not, the context moves on to the next phase, and the next phase is processed. However, if the context has reached the last phase of the software pipeline for this context, then this last phase marks the flow still in the context as no longer being active (block 724). At block 725 the last phase determines if there is data in the shunt buffer and whether the shunt buffer is currently not being processed. If not, the last phase is terminated (block 727). However, if these conditions are met, then the shunt buffer is executed (block 726), as will be discussed next.

In one embodiment, once the packets with duplicate flow IDs have been isolated in the shunt buffer, these packets can then be processed. This process is slightly different from normal packet processing since there may be duplicate flow IDs within a given shunt buffer. Each shunt buffer is typically fully processed before the next one may execute; thus, duplicate flow IDs between shunt buffers do not cause problems. Duplicate flow IDs within the same shunt buffer will be discussed later.

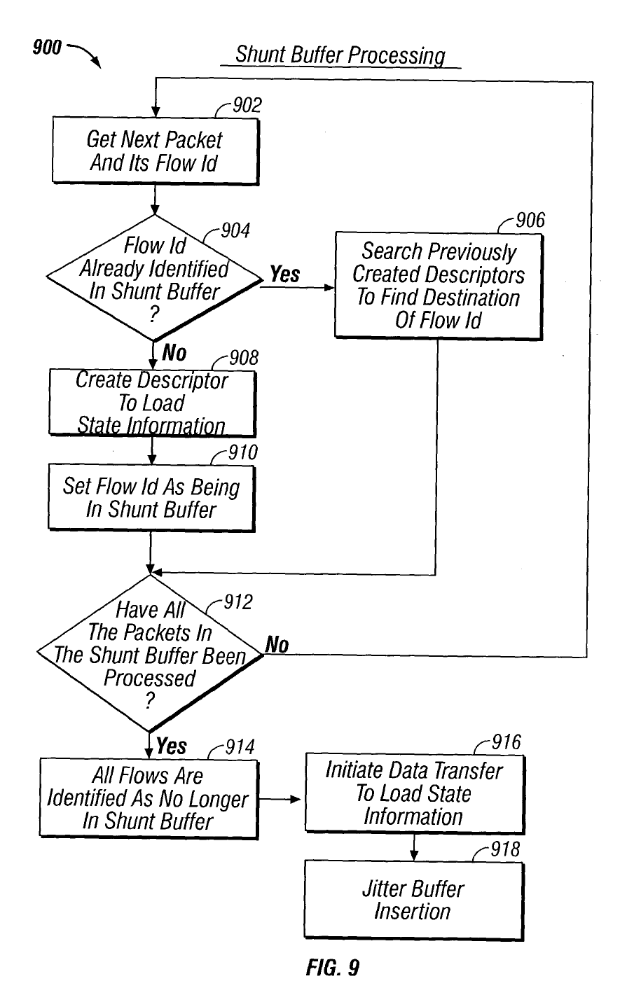

A generalized method for shunt buffer processing will now be discussed. Particularly, FIG. 9 shows a flow diagram that illustrates a generalized method of shunt buffer processing 900 according to one embodiment of the invention. In embodiments of shunt buffer processing, the top of a shunt buffer queue will typically contain the number of packets that reside in the shunt buffer. For example, in the exemplary embodiment of the shunt buffer 800, data field 802 contains the total number of packets in the shunt buffer. The shunt buffer processing method cycles through this number of packets in the shunt buffer and sets up a DMA transfer to bring in the state information. Moreover, when setting up this DMA transfer, the shunt buffer processing method 900 keeps track of the location where the state information will reside when it is brought in from external memory.

As shown in FIG. 9, at block 902 a packet and its flow ID are obtained. It should be appreciated that the shunt buffer processing method 900 is an iterative process. Next, at block 904 it is determined whether or not the flow ID has already been identified in the shunt buffer. If so, then the shunt buffer is searched for previously created DMA descriptors to find the destination of the flow ID (block 906). In other words, the shunt buffer processing method 900 searches through the list of previously processed packets to find the state information for the previous packet with the same flow ID and then points to the same location. The shunt buffer processing method 900 then proceeds to block 912, which will be discussed in detail later.

On the other hand, if the flow ID is not already identified as being in the shunt buffer, then a DMA descriptor is created to load state information (block 908). It should be appreciated that the state information may include such items as the number of packets received, sequence number information, timestamp data, jitter buffer information, etc., and other types of data typically used to describe state information in packet processing, as should be apparent to those skilled in the art. After a DMA descriptor is created, a shunt buffer flow ID flag is set to indicate that the flow ID is already in the shunt buffer (block 910).

At block 912, the shunt buffer processing method 900 determines whether all of the packets in the shunt buffer have been processed. If not, the shunt buffer processing method 900 then returns to block 902 where the next packet is obtained and the process begins again. However, if all the packets in the shunt buffer have been processed, then all of the flows are identified as no longer being in the shunt buffer (block 914). Further, a data transfer to load the state information is initiated (block 916). Lastly, jitter buffer insertion is performed (block 918).

As is known in the art, jitter buffer insertion places each packet at a correct location in the jitter buffer for a given flow. However, in the instant case, the state information's location is determined with the modified descriptor as previously discussed. After jitter buffer insertion, the final phase of shunt buffer processing may be performed. In this final phase of shunt buffer processing, all of the flow IDs previously processed are marked as no longer being in the shunt buffer, unless the same flow IDs still reside in a separate shunt buffer.

Embodiments of the invention related to soft-pipelined state-oriented packet processing techniques offer many advantages over other approaches to processing packets within a flow state. Particularly, functional correctness is preserved, even when packets are processed in groups and substantial state is maintained for each flow. Further, the duplicate flow ID assumptions, as previously discussed, enable each context to be processed more efficiently in terms of memory and computational resources thereby achieving a significant reduction in computational requirements. Moreover, because multiple contexts are actively being processed at any given time, this allows for the overlap of processor computations and DMA transfers, thus increasing packet throughput. Accordingly, throughput is increased such that the channel density of the voice packet processor is also increased. This increased density allows a high density, low-cost voice packet processing solution.

Those skilled in the art will recognize that although aspects of the invention and various functional components have been described in particular embodiments, it should be appreciated these aspects and functionalities can be implemented in hardware, software, firmware, middleware or a combination thereof.

When implemented in software, firmware, or middleware, the elements in the embodiments of the present invention are the instructions/code segments to perform the necessary tasks. The instructions which when read and executed by a machine or processor, cause the machine processor to perform the operations necessary to implement and/or use embodiments of the invention. As illustrative examples, the “machine” or “processor” may include a packet processor, a packet processor core, a digital signal processor, a microcontroller, a state machine, or even a central processing unit having any type of architecture, such as complex instruction set computers (CISC), reduced instruction set computers (RISC), very long instruction work (VLIW), or hybrid architecture. These instructions can be stored in a machine readable medium (e.g. a processor readable medium or a computer program product) or transmitted by a computer data signal embodied in a carrier wave, or a signal modulated by a carrier, over a transmission medium of communication link. The machine-readable medium may include any medium that can store or transfer information in a form readable and executable by a machine. Examples of the machine readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via networks such as the Internet, Intranet, etc.

While embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

What is claimed is:

1. A method comprising:
defining a plurality of phases;
defining a plurality of contexts, each context including a plurality of packets, the plurality of phases to process each context; and
performing a direct memory access (DMA) to obtain state data for a context being processed by a phase for use during processing by a next phase of the plurality of phases.

2. The method of claim 1, wherein the packets are voice packets.

3. The method of claim 1, further comprising determining whether a last phase has processed the context.

4. The method of claim 3, wherein if a last phase has processed the context, the state data is transferred back into a memory using a final DMA transfer.

5. The method of claim 3, wherein if a last phase has not processed the context, the next phase processes the context with the state data obtained for the context.

6. The method of claim 1, further comprising implementing a flow ID detection process to identify packets of contexts that have the same flow ID.

7. The method of claim 6, wherein if packets of contexts that have the same flow ID are identified, the packets are stored into a shunt buffer.

8. The method of claim 7, further comprising processing the packets stored in the shunt buffer.

9. A packet processor comprising:
a packet processor core coupled to a program memory and an external memory, the program memory storing a processor readable medium having instructions for use in packet processing which when executed by the packet processor core cause the packet processor core to perform the following operations:
define a plurality of phases;
define a plurality of contexts, each context including a plurality of packets, the plurality of phases to process each context; and
perform a direct memory access (DMA) to the external memory to obtain state data for a context being processed by a phase for use during processing by a next phase of the plurality of phases.

10. The packet processor of claim 9, wherein the packets are voice packets.

11. The packet processor of claim 9, wherein the packet processor core determines whether a last phase has processed the context.

12. The packet processor of claim 11, wherein if a last phase has processed the context, the state data is transferred back into the external memory using a final DMA transfer.

13. The packet processor of claim 11, wherein if a last phase has not processed the context, the next phase processes the context with the state data obtained for the context.

14. The packet processor of claim 9, wherein the packet processor core implements a flow ID detection process to identify packets of contexts that have the same flow ID.

15. The packet processor of claim 14, wherein if packets of contexts that have the same flow ID are identified, the packets are stored into a shunt buffer.

16. The packet processor of claim 15, wherein the packet processor core processes the packets stored in the shunt buffer.

17. A machine-readable medium having stored thereon instructions for use in packet processing, which when executed by a machine, cause the machine to perform the following operations comprising:
defining a plurality of phases;
defining a plurality of contexts, each context including a plurality of packets, the plurality of phases to process each context; and
performing a direct memory access (DMA) to obtain state data for a context being processed by a phase for use during processing by a next phase of the plurality of phases.

18. The machine-readable medium of claim 17, wherein the packets are voice packets.

19. The machine-readable medium of claim 17, further comprising determining whether a last phase has processed the context.

20. The machine-readable medium of claim 19, wherein if a last phase has processed the context, the state data is transferred back into a memory using a final DMA transfer.

21. The machine-readable medium of claim 19, wherein if a last phase has not processed the context, the next phase processes the context with the state data obtained for the context.

22. The machine-readable medium of claim 17, further comprising implementing a flow ID detection process to identify packets of contexts that have the same flow ID.

23. The machine-readable medium of claim 22, wherein if packets of contexts that have the same flow ID are identified, the packets are stored into a shunt buffer.

24. The machine-readable medium of claim 23, further comprising processing the packets stored in the shunt buffer.

25. A system comprising:
a network device coupling a first network to a second network, the network device having a packet processor that includes:
a packet processor core coupled to a program memory and an external memory, the program memory storing a processor readable medium having instructions for use in packet processing which when executed by the packet processor core cause the packet processor core to perform the following operations:
define a plurality of phases;
define a plurality of contexts, each context including a plurality of packets, the plurality of phases to process each context; and
perform a direct memory access (DMA) to the external memory to obtain state data for a context being processed by a phase for use during processing by a next phase of the plurality of phases.

26. The system of claim 25, wherein the packets are voice packets.

27. The system of claim 25, wherein the packet processor core determines whether a last phase has processed the context.

28. The system of claim 27, wherein if a last phase has processed the context, the state data is transferred back into the external memory using a final DMA transfer.

29. The system of claim 27, wherein if a last phase has not processed the context, the next phase processes the context with the state data obtained for the context.

30. The system of claim 25, wherein the packet processor core implements a flow ID detection process to identify packets of contexts that have the same flow ID.

31. The system of claim 30, wherein if packets of contexts that have the same flow ID are identified, the packets are stored into a shunt buffer.

32. The system of claim 31, wherein the packet processor core processes the packets stored in the shunt buffer.
